(19) United States
(12) Patent Application Publication
(10) Pub. No.: US 2011/0151063 A1
(43) Pub. Date: Jun. 23, 2011

(54) BEVERAGE CONTAINER LID SPILL PREVENTION DEVICE AND METHOD OF USE

(76) Inventor: Joan MURRAY, Washington, DC (US)

(21) Appl. No.: 12/972,038

(22) Filed: Dec. 17, 2010

Related U.S. Application Data
(60) Provisional application No. 61/289,224, filed on Dec. 22, 2009.

(51) Int. Cl. A23G 1/50; A23G 3/54; A23L 1/09; A23L 1/221; A23L 1/36; B23P 11/00

(52) U.S. Cl. 426/96; 426/631; 426/89; 426/103; 426/104; 426/650; 426/634; 426/632; 29/428

(57) ABSTRACT

An ingestible stopping device that prevents liquid contained in a container from passing through an opening of a lid joined to the container. The ingestible stopping device includes an opening covering portion sized to cover the opening of the lid and an extension portion sized to extend through the opening of the lid into an interior of the container. The opening covering portion prevents liquid from passing through the opening of the lid when the extension portion is inserted through the opening of the lid. The ingestible stopping device is made of an edible material such as chocolate and may be flavored. The ingestible stopping device may be coated with a second edible material having a higher melting point than the edible material.

This application claims priority to U.S. Provisional Application No. 61/289,224, which was field on Dec. 22, 2009, the entirety of which is incorporated by reference herein.

### FIELD OF THE INVENTION

Aspects of the present invention relate to a device and method of use for preventing spills from beverage containers, and in particular to the use of edible or otherwise readily degradable items sized to fit beverage lid drink openings, such as normally unobstructed drinking openings in hot beverage cup lids.

### BACKGROUND

There is an unmet need in the related art for more environmentally conscious devices and methods for preventing spills of beverages from disposable beverage containers.

### SUMMARY

Aspects the present invention overcome the above identified and other problems of the related are in preventing spills of beverages from beverage containers. Among other things, variations of devices and methods of use in accordance with aspects of the present invention would reduce the proliferation of non-biodegradable or less biodegradable (e.g., plastic) items now commonly inserted into coffee cup and other beverage lids to prevent spills.

For example, variations of the device in accordance with aspects of the present prevent may be used to prevent coffee from spilling from the small drinking opening (“hole”) typically found in the top of lids (see, e.g., lid 100 having drinking opening 101, shown in FIG. 1), which is typically used to cover cups sold at various establishments (e.g., for coffee or other beverage containing cups).

In some variations of the present invention, the device is made of an ingestible material or partially made of an ingestible material and sized and shaped to be inserted into and temporarily retained in a lid opening to reduce the likelihood of inadvertent spills from the opening. For example, the device may be made of or include portions made of chocolate or other ingestible material. In some variations, for example, to ensure that the ingestible material (e.g., chocolate) does not melt or otherwise degrade in its usefulness for preventing spills and/or minimizing mess, the ingestible material may be coated or otherwise protected with another material that has a higher melting point or other degradation resistant property. For example, a chocolate device with a relatively low melting point may be coated with a glaze or sugar sprinkles, or a cookie-type substance, among other things, having a much higher melting point than the chocolate.

To drink the beverage contained in the container, the device may simply be removed by the consumer, who may then drink the beverage in the container via the unobstructed opening in the lid. In addition to being able to return the device to the opening when pausing from drinking, the consumer or other user may also temporarily remove the beverage lid and deposit the device into the beverage, where, for example, it may melt and add flavor to the beverage.

In some variations, the device may be made to include one or more particularly flavors suitable for certain purposes, such as compatibility with the flavor of coffee, including, for example:

1) Mocha;

2) Hazlenut;

3) A vegan chocolate; or

4) Sugar-free chocolate.

### BRIEF DESCRIPTION OF THE DRAWINGS

Aspects of the present invention will become fully understood from the detailed description given herein below and the accompanying drawings, which are given by way of illustration and example only and thus not limited to aspects of the present invention, wherein:

FIG. 1 is a perspective view of an exemplary lid that may be used in conjunction with aspects of the present invention;

FIG. 2 is a side view of an exemplary device in accordance with aspects of the present invention;

FIG. 3 is a side view of another exemplary device in accordance with aspects of the present invention;

FIG. 4 is a side view of an exemplary beverage container that may be used in conjunction with aspects of the present invention; and

FIG. 5 is side, partial cutaway view of a lid used in conjunction with a device of the present invention.

### DETAILED DESCRIPTION

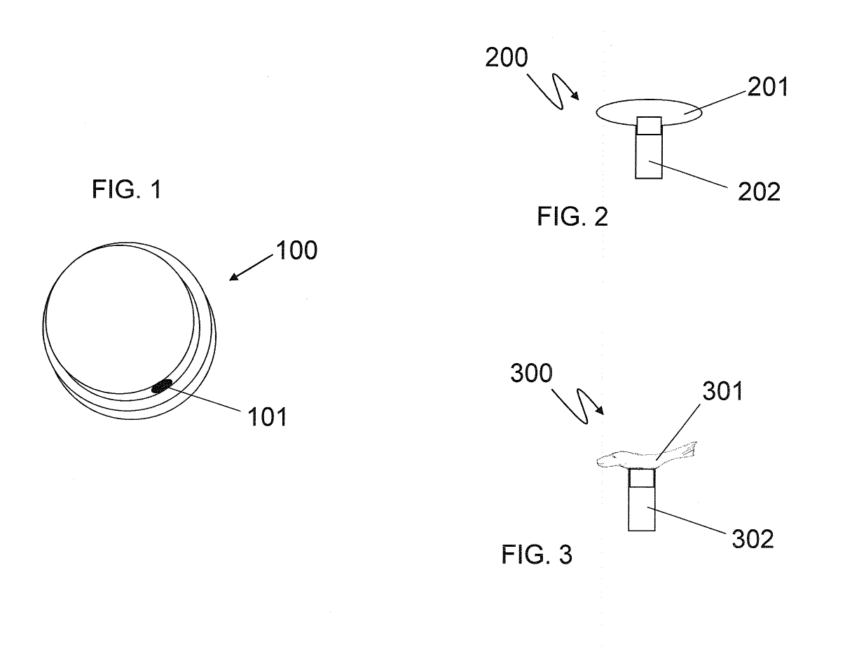

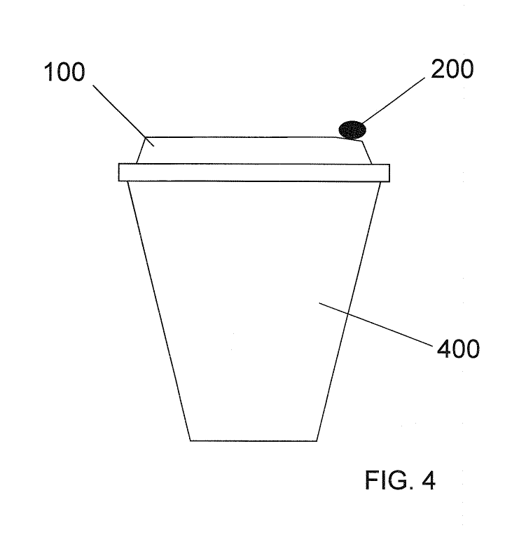

FIG. 1 shows an exemplary lid 100 having an opening 101. The lid 100 is sized to cover a beverage container (see e.g., beverage container 400 of FIG. 4), while the opening 101 is sized to allow a user to meter a desired amount of liquid contained in the cup into the user's mouth.

FIG. 2 shows an exemplary device 200 that may be used in conjunction with the lid 100 of FIG. 1. In one exemplary variation, the size of the device is about one centimeter in diameter and shaped to cover the top of an opening about two to three centimeters in length. For example, as shown in FIG. 2, the device may include a opening covering portion 201, sized to cover the opening 101 of a lid 100, as shown in FIG. 1, and an extension portion 202 sized to extend through the opening 101 of lid 100, as shown in FIG. 1, into the interior of the beverage container when the lid is placed thereon.

FIG. 4 shows an exemplary beverage container 400 with a lid 100 emplaced thereon to contain a beverage or other liquid. In use, the extension portion of the device 200 is inserted though the opening in lid 100, such that the covering portion of the device 200 covers the hole of the lid 100. Furthermore, as shown in FIG. 4, the cover portion of the device 200 protrudes externally from the hole, thereby covering the hole.

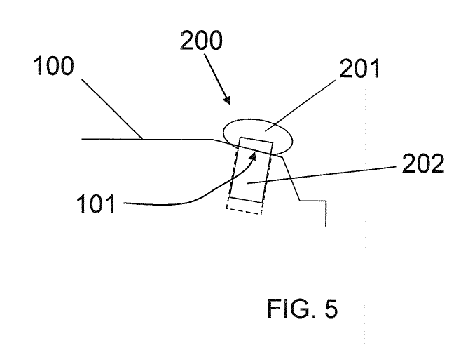

FIG. 5 shows a side, partial cutaway view of a lid 100 and the device 200 in use. As shown in FIG. 5, covering portion 201 of device 200 closes opening 101 of lid 100, with extension portion 202 of device 200 extending through opening 101. Thus, the device 200 prevents the liquid contained within the beverage container from spilling out of the opening 101.

FIG. 3 shows another exemplary version of a device 300 having a covering portion 301 shaped or formed as an object, such as an animal (e.g., such as in the shape of a seal, as shown in FIG. 3), with extending portion 302 extending from covering portion 301. This variation may be used, for example, by companies having animal or other associated logos suitable for shaping and use as the device covering portion and wishing to advertise or otherwise call attention to their companies via distribution of the device, or similarly used by other parties wishing to publicize (e.g., an animal rights group wishing to publicize an issue).

In some variations of the present invention, the device is made of an ingestible material or partially made of an ingestible material. For example, the device may be made of or include portions made of chocolate or other ingestible material. In some variations, for example, to ensure that the ingestible material (e.g., chocolate) does not melt or otherwise degrade in its usefulness for preventing spills and/or minimizing mess, the ingestible material may be coated or otherwise protected with another material that has a higher melting point or other degradation resistant property. For example, a chocolate device with a relatively low melting point may be coated with a glaze or sugar sprinkles, or a cookie-type substance, among other things, having a much higher melting point than the chocolate.

To drink the beverage contained in the container, the device may simply be removed by the consumer, who may then drink the beverage in the container via the unobstructed opening in the lid. In addition to being able to return the device to the opening when pausing from drinking, the consumer or other user may also temporarily remove the beverage lid and deposit the device into the beverage, where, for example, it may melt and add flavor to the beverage.

In some variations, the device may be made to include one or more particularly flavors suitable for certain purposes, such as compatibility with the flavor of coffee, including, for example:

1) Mocha;

2) Hazlenut;

3) A vegan chocolate; or

4) Sugar-free chocolate.

Exemplary aspects of the present invention have now been described in accordance with the above advantages. It will be appreciated that these examples are merely illustrative of the invention. Many variations and modifications will be apparent to those skilled in the art.

1. An ingestible stopping device for preventing liquid contained in a container from passing through an opening of a lid joined to the container, the device comprising:
an opening covering portion sized to cover the opening of the lid;
an extension portion sized to extend through the opening of the lid into an interior of the container; and
an ingestible material.

2. The ingestible stopping device of claim 1, wherein a diameter of the covering portion is greater than a width of the opening.

3. The ingestible stopping device of claim 2, wherein the opening covering portion is about one centimeter in diameter and the opening is about two to three centimeters in length.

4. The ingestible stopping device of claim 1, wherein the ingestible material is at least partially made of chocolate.

5. The ingestible stopping device of claim 1, wherein the ingestible material is coated with a second ingestible material that has a higher melting point than the ingestible material.

6. The ingestible stopping device of claim 2, wherein the ingestible material is made of chocolate and the second ingestible material is one of a glaze, sugar sprinkles, and a cookie.

7. The ingestible stopping device of claim 1, wherein the open covering portion has the shape of an animal or logo.

8. The ingestible stopping device of claim 1, further comprising at least one flavoring.

9. The ingestible stopping device of claim 8, wherein the at least one flavoring is selected from the group consisting of: mocha, hazelnut, vegan chocolate, and sugar-free chocolate.

10. The ingestible stopping device of claim 1, further comprising a biodegradable material.

11. A method of preventing liquid contained in a container from passing through an opening of a lid joined to the container, the method comprising:
inserting an extension portion of an ingestible stopping device through the opening of the lid into an interior of the container; and
covering the opening of the lid with a covering portion of the ingestible stopping device,
wherein the ingestible stopping device includes an ingestible material.

12. The method of claim 11, wherein a diameter of the covering portion is greater than a width of the opening.

13. The method of claim 12, wherein the opening covering portion is about one centimeter in diameter and the opening is about two to three centimeters in length.

14. The method of claim 11, wherein the ingestible stopping device is at least partially made of chocolate.

15. The method of claim 11, wherein the ingestible stopping device is coated with a second ingestible material that has a higher melting point than the ingestible material.

16. The method of claim 15, wherein the ingestible material is made of chocolate and the second ingestible material is one of a glaze, sugar sprinkles, and a cookie.

17. The method of claim 11, wherein the ingestible stopping device comprises at least one flavoring selected from the group consisting of: mocha, hazelnut, vegan chocolate, and sugar-free chocolate.

18. The method of claim 11, wherein the ingestible stopping device comprises a biodegradable material.
